(19) United States
(12) Patent Application Publication
(10) Pub. No.: US 2002/0122374 A1
(43) Pub. Date: Sep. 5, 2002

(54) Optical recording medium, optical information processing apparatus and optical recording and reproducing method

(75) Inventors: Hiroaki Yamamoto, Kawabe-gun (JP); Teruhiro Shiono, Osaka-shi (JP); Tetsuo Saimi, Hirakata-shi (JP)

Correspondence Address: MERCHANT & GOULD PC, P.O. BOX 2903, MINNEAPOLIS, MN, 55402-0903, US

(73) Assignee: Matsushita Electric Industrial Co., Ltd, Kadoma-shi (JP)

(21) Appl. No.: 10/086,944

(22) Filed: Feb. 28, 2002

(30) Foreign Application Priority Data
Mar. 2, 2001 (JP) 2001-057747

(51) Int. Cl. G11B 7/00

(52) U.S. Cl. 369/108

(57) ABSTRACT

An optical recording medium of the present invention includes a recording layer, in which information is recorded in a three-dimensional manner in an in-plane direction and a thickness direction of the recording layer. The recording layer includes a thermochromic material whose color changes reversibly according to a temperature. The thermochromic material converts absorbed light into heat, increases its light absorptance as the temperature rises and, when the temperature reaches a first predetermined temperature or higher, changes irreversibly to a translucent substance whose color does not change according to a temperature change. In this optical recording medium, since only the position on which irradiated light is focused develops color so as to increase light absorptance, this property is utilized for recording and reproducing information.

### BACKGROUND OF THE INVENTION

1. Field of the Invention

The present invention relates to an optical recording medium, an optical information processing apparatus and an optical recording and reproducing method for optically recording information on and reproducing information from an optical disk, an optical card or the like.

2. Description of Related Art

In recent years, with an increasingly information oriented society, large capacity external memories have been demanded. Conventionally, in optical information recording, because of the diffraction-limited state determined by a wavelength of light and a numerical aperture of an objective lens, there have been limits on the densification of recording pits by reducing the size thereof. In order to solve such a problem, JP 6(1994)-28672 A has suggested an optical information processing apparatus having a configuration in which data can be recorded not only within a two-dimensional plane of a recording material but also in a depth direction (an optical axis direction). In other words, data can be recorded in the recording material in a three-dimensional manner.

FIG. 11 shows an example of a conventional optical information processing apparatus. An optical system of this apparatus includes a semiconductor laser 101 as a light source, an objective lens 102, a photosensitive material 103 on which data are recorded, a photodetector 104 for detecting light reflected by the photosensitive material 103 and a beam splitter 105 for guiding the reflected light to the photodetector 104. Light emitted from the semiconductor laser 101 is focused on the photosensitive material 103 by the objective lens 102. As the photosensitive material 103, a LiNbO₃ crystal, which is a photorefractive crystal, is used.

In the LiNbO₃ crystal, the refractive index changes in proportion to a differentiated value of a light intensity distribution. Accordingly, when a converged light beam is made to enter the photosensitive material 103, since the light intensity on an optical axis is proportional to the reciprocal of the second power of the distance from a focal position, the change in the refractive index of the LiNbO₃ crystal is proportional to the reciprocal of the third power thereof. As a result, the change in the refractive index occurs only in the vicinity of a focal point of the light beam. By utilizing this change in the refractive index, data can be recorded in the LiNbO₃ crystal in a three-dimensional manner. The data can be read out by focusing the light beam emitted from the semiconductor laser 101 onto a portion in which the refractive index is changed and detecting the reflected light beam from this portion with the photodetector 104.

However, in the conventional technology described above, since information is recorded by utilizing the change in the refractive index of the crystal of the photosensitive material 103, the incident laser beam is scattered by recording marks present on its optical path, leading to insufficient focusing characteristics and light intensity. Thus, recording and reproducing characteristics are not sufficient, presenting obstacles to an increase in recording density.

### SUMMARY OF THE INVENTION

It is an object of the present invention to provide an optical recording medium, an optical information processing apparatus and an optical recording and reproducing method that achieve sufficient focusing characteristics and light intensity so as to improve recording and reproducing characteristics.

In order to achieve the above-mentioned object, an optical recording medium of the present invention includes a recording layer, in which information is recorded in a three-dimensional manner in an in-plane direction and a thickness direction of the recording layer. The recording layer includes a thermochromic material whose color changes reversibly according to a temperature, and the thermochromic material converts absorbed light into heat and increases its light absorptance as the temperature rises. The three-dimensional recording in the present invention refers to a recording in which a plurality of recording marks are present on the same optical axis. Such a recording may include a multilayer recording in which many recording layers are layered and a state where recording data are provided in the thickness direction at random because the recording data do not need to be contained in the same plane.

With this optical recording medium, when reproducing recorded information, it is possible to irradiate converged light on the recording layer, bring a focusing portion of this converged light into correspondence with a reproducing position in which the information to be reproduced is recorded and raise the temperature of only the reproducing position so as to increase the light absorptance of this position. This is made possible because of the fact that the light intensity and, thus, the temperature increase are greatest in the focusing position. In this manner, the light absorptance of only the reproducing position can be raised without increasing the light absorptance of positions other than the reproducing position. Accordingly, by detecting a light transmittance or a light reflectance and reproducing the information, it is possible to reproduce signals with less crosstalk. Incidentally, there is no particular limitation on how the information to be reproduced by such a method is recorded.

Furthermore, in the above-described optical recording medium of the present invention, it is preferable that the thermochromic material changes irreversibly to a translucent substance whose color does not change according to a temperature change, when the temperature reaches a first predetermined temperature or higher. This property of the thermochromic material can be utilized for recording the information on the optical recording medium of the present invention. More specifically, converged light is irradiated on the recording layer so as to be focused onto a recording position in which the information is to be recorded, and the temperature of this recording position is raised to the first predetermined temperature or higher, so that the thermochromic material is changed to the translucent substance whose color does not change according to the temperature change. This substance serves as a recording mark. The recording mark formed as above has a transmittance that does not change by irradiation of light and has substantially the same refractive index as other portions. Consequently, even when the recording mark is present on the optical path, the light beam is not scattered by the recording mark very easily, thus achieving sufficient focusing characteristics and light intensity.

In order to achieve the above-mentioned object, an optical information processing apparatus of the present invention includes an optical recording medium, a radiation light source, a focusing optical system for focusing light emitted from the radiation light source onto a minute spot (, which has an approximate size of a diffraction-limited spot in the optical system) on the optical recording medium, and a photodetector for receiving the light transmitted or reflected by the optical recording medium and outputting a reproducing signal. The optical recording medium includes a recording layer including a thermochromic material whose color changes reversibly according to a temperature. The thermochromic material has a property of converting absorbed light into heat and increasing its light absorptance as the temperature rises, and information is recorded in a three-dimensional manner in an in-plane direction and a thickness direction of the recording layer. Furthermore, in the optical information processing apparatus of the present invention, it is preferable that the thermochromic material used in the recording layer of the optical recording medium changes irreversibly to a translucent substance whose color does not change according to a temperature change, when the temperature reaches a first predetermined temperature or higher.

This optical information processing apparatus includes the optical recording medium of the present invention. As described above, with the use of the optical recording medium of the present invention, sufficient focusing characteristics and light intensity can be obtained at the time of recording and reproducing, and thus, recording and reproducing characteristics improve. Therefore, a similar effect can be obtained in the optical information processing apparatus of the present invention including this optical recording medium.

In order to achieve the above-mentioned object, an optical recording and reproducing method of the present invention is for performing recording and reproducing with respect to an optical recording medium including a recording layer including a thermochromic material whose color changes reversibly according to a temperature. The thermochromic material has a property of converting absorbed light into heat and increasing its light absorptance as the temperature rises, and information is recorded in a three-dimensional manner in an in-plane direction and a thickness direction of the recording layer. The information is recorded in and reproduced from the recording layer by irradiating converged light at a predetermined position in the recording layer and raising a temperature of the predetermined position. Furthermore, in the optical recording and reproducing method of the present invention, it is preferable that the thermochromic material used in the recording layer of the optical recording medium changes irreversibly to a translucent substance whose color does not change according to a temperature change, when the temperature reaches a first predetermined temperature or higher.

This optical recording and reproducing method is a method for recording and reproducing the information using the optical recording medium of the present invention. As described above, with the use of the optical recording medium of the present invention, sufficient focusing characteristics and light intensity can be obtained at the time of recording and reproducing, and thus, recording and reproducing characteristics improve. Therefore, a similar effect can be obtained in the optical recording and reproducing method of the present invention using this optical recording medium.

Other objects, characteristics and advantages of the present invention will be understood fully by the following description. The benefit of the present invention also will become apparent from the following description with reference to the accompanying drawings.

### BRIEF DESCRIPTION OF THE DRAWINGS

FIG. 1 is a sectional view showing how to perform recording and reproducing with respect to an optical recording medium according to a first embodiment of the present invention.

FIG. 2 shows temperature characteristics of a thermochromic material used in the optical recording medium according to the first embodiment of the present invention.

FIG. 3 is a drawing for describing a schematic configuration of an optical information processing apparatus according to the first embodiment of the present invention.

FIG. 4 is a drawing showing the relationship of fluctuation of a signal amplitude of an entire signal component and a high-frequency signal component with respect to an output of a laser beam.

FIG. 5 is a sectional view showing how to perform super-resolution recording and reproducing using the optical recording medium according to the first embodiment of the present invention.

FIG. 6 shows the relationship of a temperature distribution of a recording layer and a region in which a color-development portion is formed with respect to a focusing spot of a laser beam.

FIG. 7 is a sectional view showing how to perform recording and reproducing using an optical recording medium according to a second embodiment of the present invention.

FIG. 8 illustrates a schematic configuration of an optical information processing apparatus according to the second embodiment of the present invention.

FIG. 9 is a sectional view showing a structure of an optical recording medium according to a third embodiment of the present invention.

FIG. 10 is a sectional view showing a structure of an optical recording medium according to a fourth embodiment of the present invention.

FIG. 11 illustrates a schematic configuration of a conventional optical information processing apparatus.

### DESCRIPTION OF THE PREFERRED EMBODIMENTS

First Embodiment

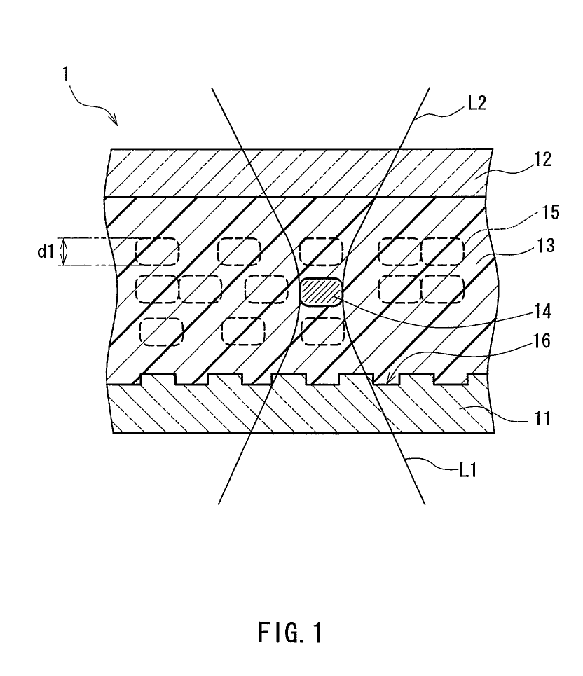

The following is a description of an optical disk, which is an optical recording medium, and an optical information processing apparatus according to the first embodiment of the present invention. FIG. 1 is a sectional view showing a schematic structure of a main portion of an optical disk 1, which is the optical recording medium of the present embodiment. The optical disk 1 of the present embodiment includes disc-like substrates 11 and 12 arranged so as to oppose each other and a recording layer (a recording region) 13 sandwiched by these substrates 11 and 12. The recording layer 13 includes a thermochromic material that absorbs a light beam emitted from a laser light source and whose light absorptance increases when a temperature increases due to this light absorption. In this case, a thermochromic material that generates heat by the light absorption is used.

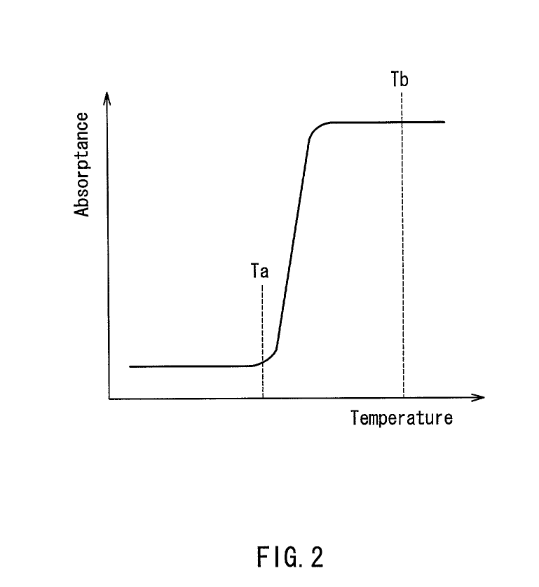

As shown in FIG. 2, the thermochromic material used for the recording layer 13 has a light absorbing property in which the light absorptance is substantially constant at a temperature lower than a thermochromism temperature Ta (a second predetermined temperature) and increases when the temperature rises to the thermochromism temperature Ta or higher. When a laser beam is irradiated, the recording layer 13 first absorbs the laser beam and generates heat at a temperature not higher than the thermochromism temperature Ta, so that the temperature rises. At this time, if the laser beam has a sufficiently large intensity, the temperature of the recording layer 13 exceeds the thermochromism temperature Ta, thus causing the absorptance to increase. By such a principle as described above, the recording layer 13 exhibits properties of absorbing the light beam emitted from the laser light source and increasing its light absorptance due to the temperature increase caused by this light absorption. Furthermore, when the temperature rises to a certain temperature Tb (a first predetermined temperature) or higher, the thermochromic material used here changes irreversibly to a translucent substance that does not exhibit thermochromism and has a refractive index substantially the same as the original substance. The translucent substance mentioned here means a substance whose light absorptance is 1% to 10% per unit thickness, where the unit thickness indicates a recording interval d1 in the optical axis direction in FIG. 1. Also, substantially the same refractive index means a refractive index in the range that is not affected practically by reflection generated at an interface between a substance after the change and the original thermochromic material. More specifically, it is desirable that the reflectance at the interface is not more than 1%. When the reflectance at the interface is expressed by R, the refractive index of the original thermochromic material is expressed by n and the change amount in refractive index at the time of changing into the above substance is expressed by Δn, the reflectance R can be calculated by a formula of R={Δn/(2n+Δn)}²/100. From this formula, when the refractive index n is 1.5, for example, the change amount An of the refractive index preferably is 0.33 or smaller. This property is utilized to record information on the recording layer 13.

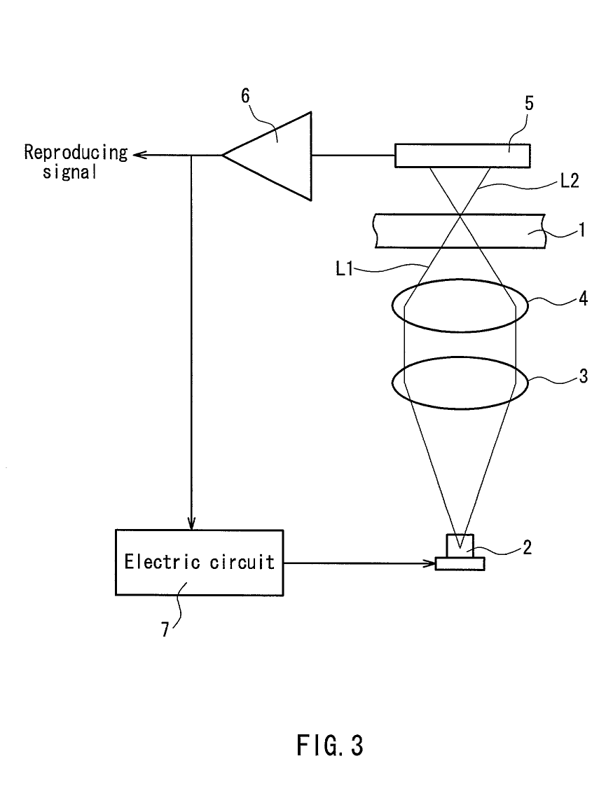

The information is written on and read out from the optical disk 1 with an optical information processing apparatus shown in FIG. 3. A laser beam from a semiconductor laser 2 is focused by a focusing optical system, which may include a collimator lens 3 and an objective lens 4, onto a predetermined position in the recording layer 13 of the optical disk 1 (light L1). The predetermined position is defined based on a guide groove 16 formed on the substrate 11 of the optical disk 1.

When the laser beam is irradiated onto the recording layer 13, an entire portion irradiated with the laser beam in the recording layer 13 slightly absorbs the laser beam, so that this portion generates heat. Owing to this heat generation, the temperature of the recording layer 13 increases, though its temperature distribution is not uniform. Since the irradiated laser beam has been converged, the light intensity and, thus, the temperature increase are greatest in a focusing position. In the focusing position in the recording layer 13, the absorptance increases sharply when the temperature exceeds the thermochromism temperature Ta, and a color-development portion 14 as shown in FIG. 1 is formed. In the color-development portion 14, an absorption amount of the laser beam increases, thus raising the temperature further. When the temperature of the thermochromic material used here reaches the predetermined temperature Tb, it changes irreversibly to a translucent substance that does not exhibit the thermochromism, so that the portion changed into this translucent substance serves as a recording mark 15 formed in the recording layer 13. In this manner, the information is recorded in the recording layer 13. In this case, even when the recording mark 15 is present on the optical path, the laser beam hardly is scattered by the recording mark 15 because the mark 15 is translucent and has substantially the same refractive index. Consequently, the information recording on the optical disk 1 has reduced light absorption and scattering in the position other than the recording position, thus achieving excellent light utilization efficiency and focusing characteristics.

Next, a method for reproducing a recorded signal will be described. Basically, the recorded information also is reproduced using a laser beam emitted from the semiconductor laser 2. As in the case of recording, the focusing optical system, which may include the collimator lens 3 and the objective lens 4, focuses the laser beam onto the optical disk 1. The focused laser beam (light L1) is transmitted by the optical disk 1, the transmitted light (light L2) is detected by a photodetector 5, and the amplitude of a detected signal is amplified by a head amplifier 6, thus obtaining a reproducing signal.

The transmittance of the optical disk 1 varies according to the state of the recording layer 13 at the position where the light L1 is focused. When the recording mark 15 already has been formed on the spot where the light L1 is focused, the color-development portion 14 is not formed at this position, so that the transmittance is high. On the other hand, when the recording mark 15 has not been formed on the spot where the light L1 is focused, the color-development portion 14 is formed so as to lower the transmittance as in the case of recording. The optical information processing apparatus of the present embodiment detects this difference in transmittance by the intensity of the light L2, thereby reading out the information. In either case, since the recording layer 13 develops no color in the portion other than the focusing portion, it is possible to reproduce signals with less crosstalk. Furthermore, even when the recording mark 15 is present on the optical path, there is no significant absorption and scattering in the portion other than the focusing portion because the recording mark 15 is translucent and has substantially the same refractive index. This allows a highly efficient detection of the reproducing signal. Moreover, according to the present invention, a greater signal strength and an improved S/N ratio can be achieved compared with a conventional recording system utilizing the difference in refractive index. Incidentally, there is no particular limitation on how the information to be reproduced by the above-described method is recorded. The information may be recorded using the above-described recording method of the present embodiment or may be recorded in advance on a read-only optical disk (ROM).

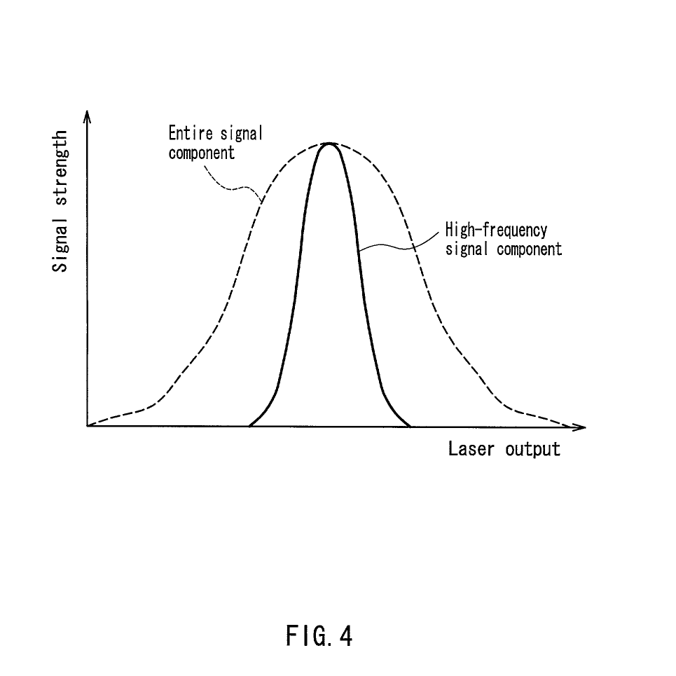

When reproducing information from the optical disk 1, the size of the formed color-development portion 14 influences a signal amplitude and an intersymbol interference. When the color-development portion 14 is smaller than the focusing spot, a region in which the transmittance is modulated is small, so that the signal amplitude decreases. When the color-development portion 14 is larger than the focusing spot, the color-development portion 14 is formed even in a region adjacent to the focusing spot, so that the intersymbol interference increases and the signal amplitude lowers. Such a tendency is significant when a small recording mark is reproduced, namely, in the range of a signal component at high frequencies (a high-frequency signal component). FIG. 4 shows the fluctuation of the signal amplitude of an entire signal component and the high-frequency signal component with respect to an output of the laser beam. As becomes clear from this figure, when the output of the laser beam is raised for the purpose of forming the color-development portion 14 larger than the focusing spot, for example, the signal amplitude of the high-frequency signal component drops considerably. In order to solve such a problem, the optical information processing apparatus of the present embodiment uses an electric circuit (a control portion) 7 as shown in FIG. 3.

The electric circuit 7 includes a circuit for detecting the signal amplitude obtained from the head amplifier 6 and a circuit for controlling the laser output of the semiconductor laser 2 so that this signal amplitude is kept at a maximum. As shown in FIG. 4, since the amplitude of the obtained signal varies according to the laser output, it is desirable that the laser output is adjusted so that the obtained signal amplitude is at the maximum. By the above-described operation of the electric circuit 7, the size of the color-development portion 14 always is controlled optimally, thus allowing a stable signal reproduction. Since the fluctuation of the signal amplitude with respect to the laser output increases in keeping with the frequency of the signal component as described above, by providing the circuit for detecting the signal amplitude in the electric circuit 7 with a function of detecting only the amplitude of the high-frequency signal component, a further improvement in detecting sensitivity can be achieved, making it possible to detect signals stably.

For the recording layer 13, the present embodiment uses the thermochromic material that develops color so as to increase its light absorptance when the temperature rises, converts the absorbed light into heat and, at a predetermined temperature or higher, changes irreversibly to a translucent substance whose color does not change according to a temperature change. Such a material can be obtained, for example, by adding 0.5 g of a phthalocyanine dye as a sensitizer to a thermochromic material containing 1 g of crystal violet lactone and 20 g of distearylphosphate. Also, a N,N-diethylethylenediamine complex ([CuL₂](NO₃)₂, L: N,N-diethylethylenediamine) can be used.

Furthermore, according to the optical disk 1 and the optical information processing apparatus of the present embodiment, it becomes possible to perform reproduction of a mark that is equal to or smaller than a diffraction-limited mark, the so-called super-resolution recording and reproducing. The following is a description of an operation of the super-resolution recording and reproducing with respect to the optical disk 1 of the present embodiment.

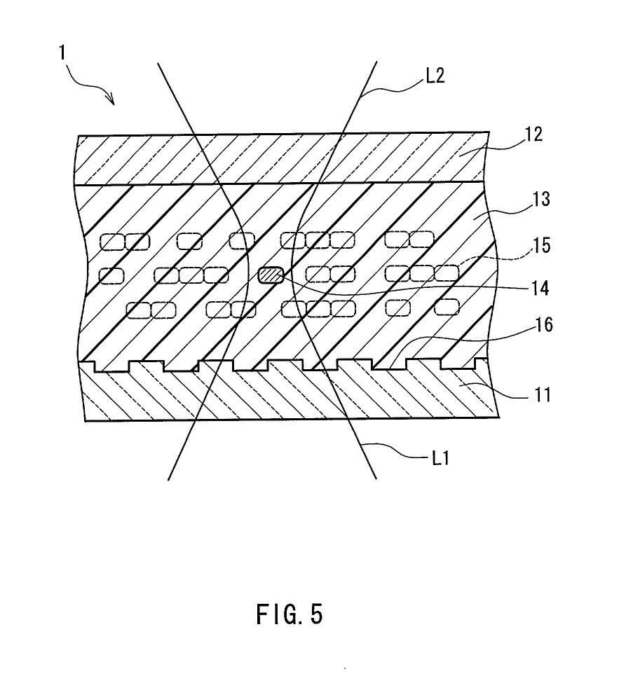

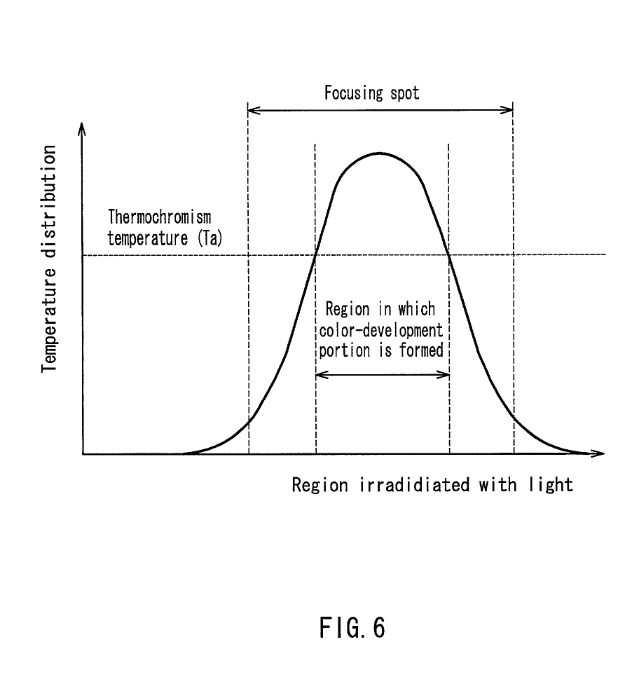

FIG. 5 is a sectional view showing how to perform the super-resolution recording and reproducing using the optical disk 1. When reproducing information from the optical disk 1, the color-development portion 14 can be made smaller than the focusing spot. In the following, a region in which the color-development portion 14 is formed will be described using FIG. 6, which shows the relationship between the focusing spot and the color-development portion 14.

When recording and reproducing information with respect to the optical disk 1, the temperature in the recording layer 13 is the highest in the central portion of the focusing spot and the values indicating the temperature form a unimodal-shaped distribution. The color-development portion 14 is formed in a portion in the recording layer 13 where the temperature reaches the thermochromism temperature Ta or higher. Thus, by selecting the intensity of the light L1 suitably and irradiating the light L1, it is possible to form the color-development portion 14 in a region smaller than the focusing spot. In this state, the reproducing signal is generated only in the color-development portion 14, and information located in a region of the focusing spot where no color-development portion is formed is not detected as a signal. This makes it possible to detect the recording mark 15 that is equal to or smaller than a diffraction-limited mark. In this super-resolution reproducing, it is necessary to control the color-development portion 14 so as not to be larger than the minimum size of the recorded recording mark 15. It is appropriate to extract a frequency component of the recording signal corresponding to the minimum recording mark, namely a highest frequency component of the signal, with the electric circuit 7, and control the intensity of the light L1 so that the intensity of this signal amplitude is at the maximum. In the case of recording, since information will be recorded only in the color-development portion 14, it is possible to record information (form the recording mark 15) below the diffraction-limited state.

Second Embodiment

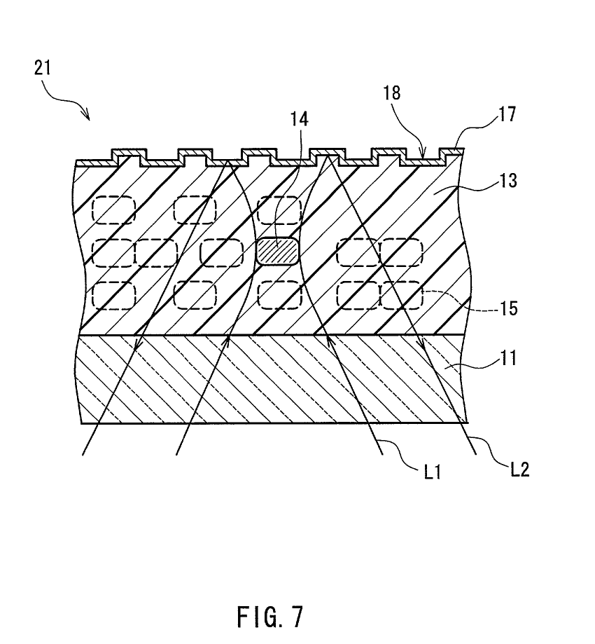

The following is a description of an optical disk 21, which is an optical recording medium according to the second embodiment. FIG. 7 shows a schematic structure of a main portion of the optical disk 21. The optical disk 21 includes the disc-like substrate 11 and the recording layer 13 used in the optical disk 1 described in the first embodiment, and further the surface of the recording layer 13 (the surface opposite to an incident side of the light L1) is provided with a reflecting film 17. A film formed of a metal such as Al may be used for the reflecting film 17.

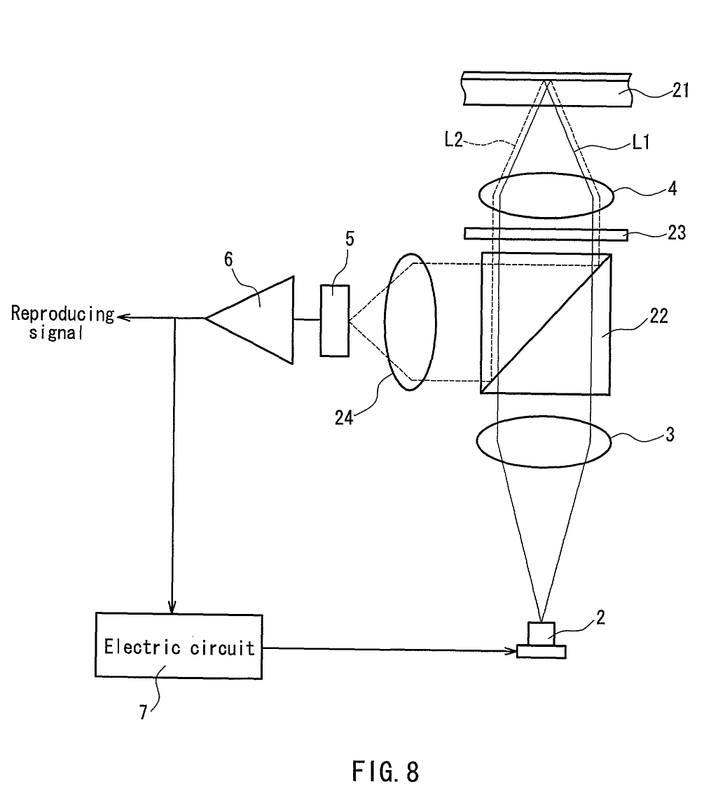

With respect to the optical disk 21, information is recorded and reproduced using an optical information processing apparatus of the present embodiment, which is shown in FIG. 8. A laser beam emitted from a semiconductor laser 2 is changed into a parallel light beam by a collimator lens 3 and then enters a polarization beam splitter 22. The polarization beam splitter 22 is disposed so as to transmit the laser beam from the semiconductor laser 2. A ¼ wave plate 23 changes the laser beam transmitted by the polarization beam splitter 22 into a circularly polarized laser beam. The laser beam transmitted by the ¼ wave plate 23 then is focused on the optical disk 21 by an objective lens 4 (L1). The information is recorded with the light L1 focused on the optical disk 21 as in the optical information processing apparatus of the first embodiment. Also, the recorded information is reproduced utilizing the difference in transmittance between a portion provided with a recording mark 15 and that with no mark 15, as in the first embodiment.

However, in the optical disk 21, light L2 that has detected the information is reflected by the reflecting film 17 and made to enter the side of the substrate 11 as shown in FIG. 8. The light L2 reflected by the reflecting film 17 enters the objective lens 4 again, is changed into a substantially parallel light and then enters the ¼ wave plate 23. The light L2 is changed into linearly polarized light by the ¼ wave plate 23 and reflected by the polarization beam splitter 22. The light L2 further is focused on a photodetector 5 by a detecting lens 24 so as to be detected as a reproducing signal. The detecting lens 24 and the photodetector 5 are arranged so that the light is focused on the photodetector 5 when the light L1 is focused onto substantially the center of a recording range in a thickness direction of the recording layer 13. In this manner, the area of the photodetector 5 can be minimized. In order to reproduce signals excellently, the photodetector 5 has to have a size satisfying the following formula:

φ_{PD}≧(t·f_{D}·φ_{OL})/(2f_{OL})

where φ_{PD} indicates a diameter of an inscribed circle of the photodetector 5, t indicates the recording range in the thickness direction of the recording layer 13, f_{D} indicates a focal length of the detecting lens 24, φ_{OL} indicates an effective aperture of the objective lens 4, and f_{OL} indicates a focal length of the objective lens 4. A servo signal can be detected by detecting a guide groove 18, which can be made from unevenness formed on the reflecting film 17.

In the optical information processing apparatus of the first embodiment, the focusing optical system and the photodetector have to be arranged on opposite sides with respect to the optical disk 1. With this configuration, it is necessary to move the focusing optical system and the photodetector at the same time when accessing data, and therefore, the mechanism of this apparatus is complicated. Furthermore, with this optical information processing apparatus, it is difficult to reproduce conventional reflecting-type optical disks such as CDs and DVDs. On the other hand, with the optical disk 21 and the optical information processing apparatus of the present embodiment, it is not necessary to arrange the optical systems on opposite sides with respect to the optical disk 21, and thus the mechanism of the apparatus can be simpler. Also, the optical systems in the optical information processing apparatus of the present embodiment have an optical configuration capable of reproducing conventional reflecting-type optical disks. In addition, the optical information processing apparatus and the optical disk 21 of the present embodiment also can perform the super-resolution recording and reproducing described in the first embodiment.

Third Embodiment

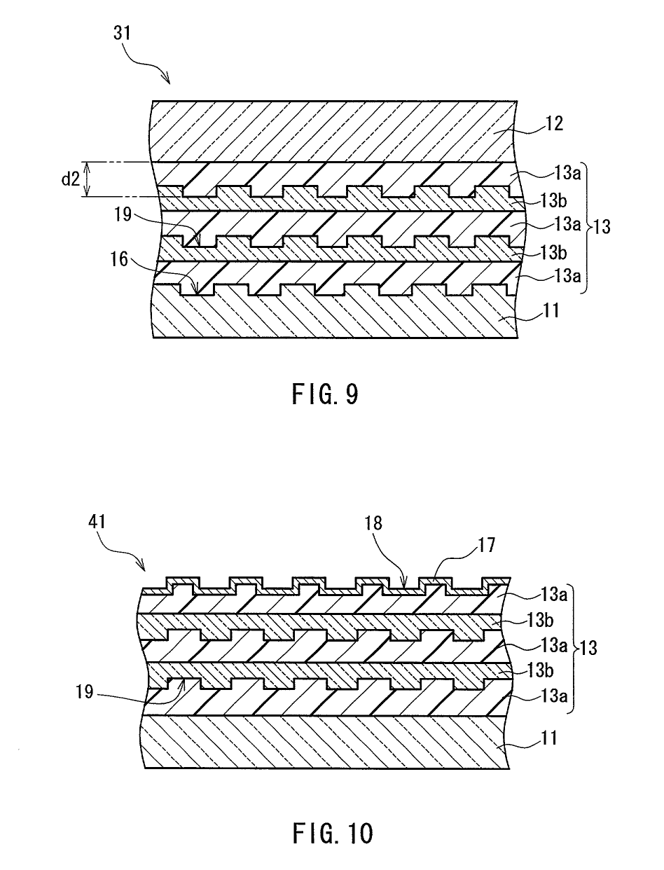

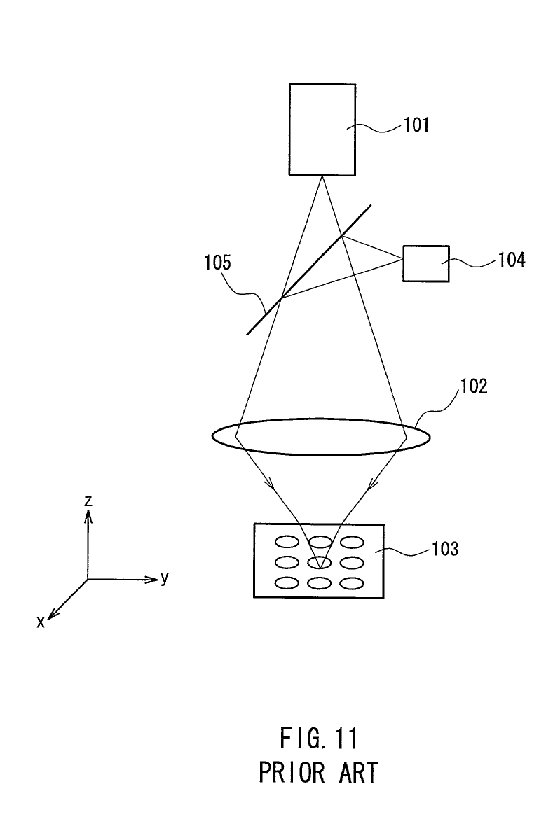

The following is a description of an optical disk 31, which is an optical recording medium according to the third embodiment. FIG. 9 is a sectional view showing a schematic structure of a main portion of the optical disk 31. The optical disk 31 has a configuration in which the recording layer 13 of the optical disk 1 described in the first embodiment is divided into a plurality of recording sublayers 13a by separating films 13b formed of a translucent material. In other words, the recording layer 13 is provided between the substrates 11 and 12, and the recording layer 13 includes the recording sublayers 13a formed of a thermochromic material and the separating films 13b formed of a translucent material. A guide groove 19 is formed on one surface of the recording sublayer 13a.

The separating film 13b serves to restrict spreading of the recording mark in the thickness direction. Accordingly, it is desirable that the separating film 13b has a thickness sufficient to separate the recording sublayers 13a thermally, and it is preferable that it has a thickness of 1 μm or more. In the case of the optical disk 1 of the first embodiment where the separating film 13b is not provided, the resolving power of the recording mark is determined by the depth of focus of the optical system. On the other hand, in the optical disk 31, since the thermochromic material serving as a recording material is separated by the translucent material so as to form a plurality of the recording sublayers 13a, the resolving power in the thickness direction is determined by the thickness of the recording sublayers 13a. In other words, the thickness of the recording sublayers 13a is made smaller than the depth of focus of the optical system, thereby improving the resolving power. This makes it possible to secure a sufficient distance between the recording sublayers 13a, thus obtaining excellent recording and reproducing characteristics. When the thickness of the recording sublayers 13a is expressed by d2, the refractive index of the recording material is expressed by n and wavelength of light is expressed by λ, it is desirable that the thickness d2 satisfies d2=λ/(2n). In addition, it is preferable that each of the recording sublayers 13a has a light absorptance of 1% to 10%. Furthermore, each of the recording sublayers 13a can be provided with unevenness for a positional detection (the guide groove 19) such as a tracking guiding groove and an address pit independently, so that a tracking servo signal can be obtained easily by a push-pull method or the like. Also, a focus servo signal can be obtained from reflected light on the surface of the recording sublayers 13a. The recording servo characteristics also are excellent. In addition, information is recorded in advance by the unevenness of the recording sublayers 13a, thereby realizing a read-only optical disk (ROM).

Moreover, when a material (for example, PMMA (polymethylmethacrylate)) having a refractive index different from that of the thermochromic material is used as the translucent material so as to obtain a desired reflectance, a servo signal with a still higher precision can be detected by utilizing the reflection at an interface between the recording sublayer 13a and the separating film 13b. The detected servo signal is used for a tracking control, allowing a tracking control with a still higher precision.

Fourth Embodiment

The following is a description of an optical disk 41, which is an optical recording medium according to the fourth embodiment. FIG. 10 is a sectional view showing a schematic structure of a main portion of the optical disk 41. The optical disk 41 has a configuration in which the recording layer 13 of the optical disk 21 described in the second embodiment is divided into a plurality of recording sublayers 13a by separating films 13b formed of a translucent material. In other words, the recording layer 13 and the reflecting film 17 are provided on the substrate 11, and the recording layer 13 includes the recording sublayers 13a formed of a thermochromic material and the separating films 13b formed of a translucent material. A guide groove 19 is formed on one surface of the recording sublayer 13a. Information is recorded on this optical disk 41 in a manner similar to that in the optical disk 1 of the first embodiment, while the information is reproduced by reflecting the light transmitted by the recording layer 13 with the reflecting film 17 and detecting this reflected light as in the second embodiment. Therefore, the information can be reproduced with an apparatus with a simple configuration.

Furthermore, the optical disk 41 makes it possible to perform recording and reproducing with an excellent resolving power in the thickness direction as in the optical disk 31 of the third embodiment, and thus a focus servo signal and a tracking servo signal can be obtained by a simple method. Moreover, it is possible to provide a read-only disk (ROM) on which information is recorded in advance.

As described above, according to the optical recording medium, the optical information processing apparatus and the optical recording and reproducing method of the present invention, sufficient light focusing characteristics and light intensity can be obtained. As a result, it is possible to perform excellent recording and reproducing, thus allowing a high density recording and reproducing.

The invention may be embodied in other specific forms without departing from the spirit or essential characteristics thereof. The embodiments disclosed in this application are to be considered in all respects as illustrative and not restrictive, the scope of the invention being indicated by the appended claims rather than by the foregoing description, all changes that come within the meaning and range of equivalency of the claims are intended to be embraced therein.

What is claimed is:

1. An optical recording medium comprising:
a recording layer, in which information is recorded in a three-dimensional manner in an in-plane direction and a thickness direction of the recording layer;
wherein the recording layer comprises a thermochromic material whose color changes reversibly according to a temperature, and
the thermochromic material converts absorbed light into heat and increases its light absorptance as the temperature rises.

2. The optical recording medium according to claim 1, wherein the thermochromic material changes irreversibly to a translucent substance whose color does not change according to a temperature change, when the temperature reaches a first predetermined temperature or higher.

3. The optical recording medium according to claim 1, wherein the thermochromic material has a light absorptance that is constant at a temperature lower than a second predetermined temperature and increases as the temperature rises at the second predetermined temperature or higher.

4. The optical recording medium according to claim 1, wherein the recording layer is divided into a plurality of recording sublayers by a separating film formed of a translucent material.

5. The optical recording medium according to claim 4, wherein a refractive index of the translucent material is different from that of the thermochromic material.

6. The optical recording medium according to claim 1, wherein the recording layer has unevenness on its surface.

7. The optical recording medium according to claim 1, wherein a reflecting film is provided on a surface opposite to a light incident side of the recording layer.

8. An optical information processing apparatus comprising:
an optical recording medium comprising
a recording layer comprising a thermochromic material whose color changes reversibly according to a temperature,
wherein the thermochromic material has a property of converting absorbed light into heat and increasing its light absorptance as the temperature rises, and
information is recorded in a three-dimensional manner in an in-plane direction and a thickness direction of the recording layer;
a radiation light source;
a focusing optical system for focusing light emitted from the radiation light source onto a minute spot on the optical recording medium; and
a photodetector for receiving the light transmitted or reflected by the optical recording medium and outputting a reproducing signal.

9. The optical information processing apparatus according to claim 8, wherein the thermochromic material changes irreversibly to a translucent substance whose color does not change according to a temperature change, when the temperature reaches a first predetermined temperature or higher.

10. The optical information processing apparatus according to claim 8, wherein the thermochromic material has a light absorptance that is constant at a temperature lower than a second predetermined temperature and increases as the temperature rises at the second predetermined temperature or higher.

11. The optical information processing apparatus according to claim 8, further comprising a control portion for controlling an intensity of the light emitted from the radiation light source so that an amplitude of the reproducing signal is at a maximum.

12. The optical information processing apparatus according to claim 8, further comprising a control portion for detecting a high-frequency signal component, which is a signal component whose frequency is high, in the reproducing signal and controlling an intensity of the light emitted from the radiation light source so that an amplitude of the high-frequency signal component is at a maximum.

13. The optical information processing apparatus according to claim 8, further comprising a control portion for controlling an intensity of the light emitted from the radiation light source so that a region of the recording layer whose color is changed by irradiation of the light emitted from the radiation light source is smaller than the minute spot.

14. The optical information processing apparatus according to claim 8, wherein the recording layer is divided into a plurality of recording sublayers by a separating film formed of a translucent material.

15. The optical information processing apparatus according to claim 14, wherein a refractive index of the translucent material is different from that of the thermochromic material.

16. The optical information processing apparatus according to claim 8, wherein a position where the minute spot is formed in the recording layer is detected by the light reflected by a surface of the recording layer.

17. The optical information processing apparatus according to claim 8, wherein unevenness is provided on a surface of the recording layer, and a position where the minute spot is formed is detected based on a position of the unevenness.

18. An optical recording and reproducing method, the method for performing recording and reproducing with respect to an optical recording medium comprising
a recording layer comprising a thermochromic material whose color changes reversibly according to a temperature,
wherein the thermochromic material has a property of converting absorbed light into heat and increasing its light absorptance as the temperature rises, and
information is recorded in a three-dimensional manner in an in-plane direction and a thickness direction of the recording layer;
wherein the information is recorded in and reproduced from the recording layer by irradiating converged light at a predetermined position in the recording layer and raising a temperature of the predetermined position.

19. The optical recording and reproducing method according to claim 18, wherein the thermochromic material changes irreversibly to a translucent substance whose color does not change according to a temperature change, when the temperature reaches a first predetermined temperature or higher.

20. The optical recording and reproducing method according to claim 18, wherein the thermochromic material has a light absorptance that is constant at a temperature lower than a second predetermined temperature and increases as the temperature rises at the second predetermined temperature or higher.

21. The optical recording and reproducing method according to claim 18, wherein the information is reproduced from the recording layer by detecting a light transmittance or a light reflectance at the predetermined position in the recording layer.

22. The optical recording and reproducing method according to claim 18, wherein the information is recorded in the recording layer by irradiating the converged light at the predetermined position in the recording layer and raising the temperature of the predetermined position to the first predetermined temperature or higher.

23. The optical recording and reproducing method according to claim 18, wherein an intensity of the converged light is controlled so that an amplitude of an obtained reproducing signal is at a maximum.

24. The optical recording and reproducing method according to claim 18, wherein an intensity of the converged light is controlled so that a region of the recording layer whose color is changed by irradiation of the converged light is smaller than a focusing spot of the converged light.

25. The optical recording and reproducing method according to claim 18, wherein the recording layer is divided into a plurality of recording sublayers by a separating film formed of a translucent material.

26. The optical recording and reproducing method according to claim 25, wherein a refractive index of the translucent material is different from that of the thermochromic material.

27. The optical recording and reproducing method according to claim 18, wherein a position where a focusing spot of the converged light is formed in the recording layer is detected by light reflected by a surface of the recording layer.

28. The optical recording and reproducing method according to claim 18, wherein unevenness is provided on a surface of the recording layer, and a position where a focusing spot of the converged light is formed is detected based on a position of the unevenness.
